(19) United States
(12) Patent Application Publication
(10) Pub. No.: US 2009/0083288 A1
(43) Pub. Date: Mar. 26, 2009

(54) Community Based Internet Language Training Providing Flexible Content Delivery

(75) Inventors: Timon M. LeDain, Ottawa (CA); Richard Stanton, Otawa (CA); Rene Faucher, Carp (CA); Rob Mitchell, Ottawa (CA); Dan DuFeu, Ottawa (CA)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(73) Assignee: neuroLanguage Corporation, Ottawa (CA)

(21) Appl. No.: 12/235,289

(22) Filed: Sep. 22, 2008

Related U.S. Application Data
(60) Provisional application No. 60/974,187, filed on Sep. 21, 2007.

(51) Int. Cl. G06F 17/30; G06F 21/00; G06F 3/048

(52) U.S. Cl. 707/10; 726/3; 715/742; 707/E17.032

(57) ABSTRACT

A system an method for interactive English language training are provided. Web-based content units are processed and language metadata is generated comprising and stored with the content unit in a content package. A platform server facilitates access to the content unit by a user using a content player. The content provided to the user is tailored to assessment data generated by the content player enabling a custom learning experience using real-world web-based content that is appropriate to the users language training requirements.

### CROSS-REFERENCE TO RELATED APPLICATIONS

This application claims priority from U.S. Provisional Application No. 60/974,187, filed Sep. 21, 2007 and is hereby incorporated by reference.

### TECHNICAL FIELD

The present invention relates to language training and in particular to delivering English language web-based content for interactive language training.

### BACKGROUND

Providing language training and in particular English language training can be an expensive and time consuming process. The content provided to students is static and does not provide the depth and variety of learning available through a dynamic content offering. Narrated content is only provided at the original speaking rate in which it was recorded and cannot be slowed down to improve comprehension by those who cannot absorb it at its recorded rate. Programs delivered on computer media are not available for use on computers on which the program and content have not been downloaded on and content may be outdated or not relevant to a particular students needs. In addition, student interaction is limited with traditional software based language training programs limiting real world learning opportunities.

Accordingly, systems and methods that enable a community based Internet language training system involving flexible content delivery remains highly desirable.

### BRIEF DESCRIPTION OF THE DRAWINGS

Further features and advantages of the present disclosure will become apparent from the following detailed description, taken in combination with the appended drawings, in which:

FIG. 1 is schematic representation of a system for internet based language training;

FIG. 2 is a block diagram of content authoring tools;

FIG. 3 is a schematic representation of platform server partitioning;

FIG. 4 is a block diagram of content player/viewer;

FIG. 5 is a method diagram of assessment driven user streaming;

FIG. 6 is a method diagram for a conversation simulation engine;

FIG. 7 is a schematic representation of intelligent audio narration speed control;

FIG. 8 is a schematic representation of context sensitive vocabulary assistance;

FIG. 9 is a schematic representation of content creation flow for text-only original content;

FIG. 10 is a schematic representation of content flow for audio or audio/video based content;

FIG. 11 is schematic representation of manual publishing workflow;

FIG. 12 is a schematic representation of automated publishing workflow;

FIG. 13 is a schematic representation of content packaging;

FIG. 14 is an illustration of a sample user phonemic scoring chart;

FIG. 15 is a schematic representation for a custom intervention based on a user's phonemic scoring data;

FIG. 16 is a schematic showing the sample interactions between the platform server and portal; and

FIG. 17 is a method of delivering interactive language training.

It will be noted that throughout the appended drawings, like features are identified by like reference numerals.

### SUMMARY

In accordance with the present disclosure there is provided A system for providing interactive English language training through a network, the system comprising: a content database, for storing content packages comprising content units and associated language training and categorization metadata, the metadata comprises synchronized audio and transcription data associated with the content unit; and a portal web-server, for providing an interface for enabling users to interact with the content through the network; and a platform server, for providing stored content packages and delivering the content packages to users to enable interactive English language training, the platform server controlling and restricting access by the each of the users to authorized content packages and providing content metadata and user data and community performance and networking data through the portal web-server. In addition a content player is provided for accessing content packages by a user from the platform server, the content server executed on a computing device comprising: an interactive testing engine for testing the user to generate language assessment data and language skill level; pronunciation analysis engine for analyzing user speech input using a speech recognition module to determine pronunciation scores of the user for content units and for providing the determined scores to the platform server at a word and phonemic level; and synchronized transcript viewer for using the content unit metadata to provide synchronization and transcription data to the user when accessing content units.

In accordance with the present disclosure there is also provided A method of providing interactive English language training through a platform server on a network, the method comprising: receiving content packages containing content units originating from one or more native English language content sources, the content packages also comprising language, categorization, transcription and synchronization metadata for use by a content player to enable user to interact with the content unit for language training; storing and indexing the content packages on a storage device; publishing content packages to enable user access to the content packages based upon associated user privilege level; receiving pronunciation scores from content players, the determined scores defined at a word and phonemic level for each of a plurality of users based upon language assessment performed by the content player; generating a web-based portal for providing access to content packages based upon the received pronunciation scores and for providing information regarding received scores at individual user and community level.

### DETAILED DESCRIPTION

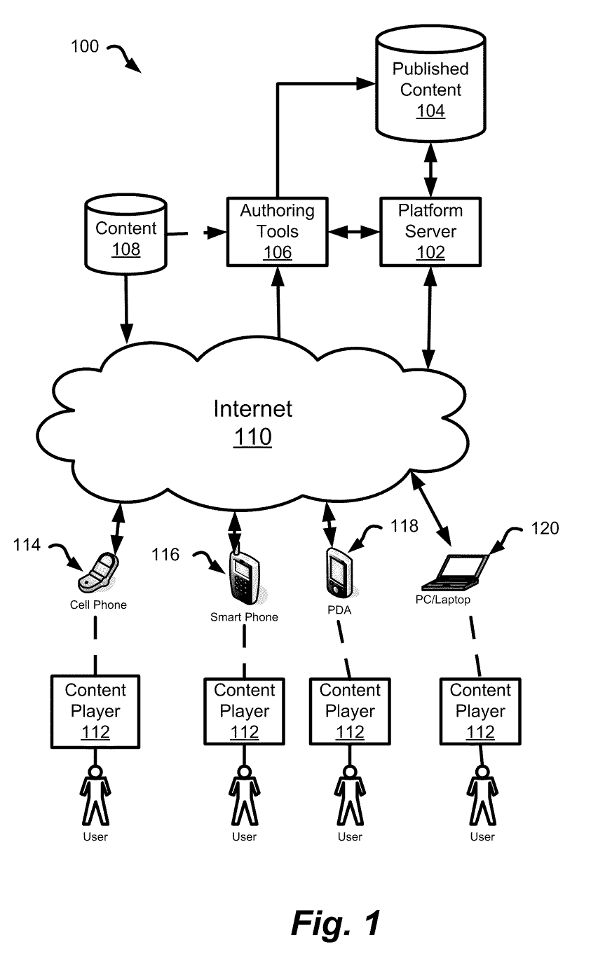

Embodiments are described below, by way of example only, with reference to FIGS. 1-17.

A system and method for community based internet language training system are provided. Users can access a media content player via any portable computing device such as a mobile phone, a smartphone, a personal digital assistant, personal computer or laptop. The content player enables the users to access language training content of the user's choosing, or recommended from a training stream. The content is specific to the desired technical area of language training. The original source content can originate from any source and is typically authored for a native English speaking audience. It is published through the platform and is thus made accessible to users who would not have otherwise been able to absorb the content in its native form. The content is processed to determine language level and complexity, in addition to synchronizing content to transcription data as well as associating it with additional descriptive metadata. The content is stored and accessed through the platform servers. The platform servers facilitate multiple users to interact in relation to the same piece of content in a learning environment over the network. Users can select to interact directly with each other in a conversation type environment or track progress of each other in relation to a specific piece of content in a non-real-time environment. The content player in conjunction with the platform servers enable the students progress through the training program to be assessed. The content player enables the content to become interactive in addition to being adapted to the learning requirements of the student. All reading or listening progress within the content itself and scores associated with any of the interactive or testing elements are securely uploaded to the platform servers to enable content players on other devices to maintain synchronization and to support detailed reporting for the user or their parent, teacher, or trainer.

A language training system is provided which provides the ability for students of varying language skill to access content authored for native English speakers and receive a tailored training program. A wide audience of users is addressed by providing a learning experience that is suited to the to users current fluency level. An assessment component is used to quantify the user's current abilities and provide content that is suitable for their learning level. At varying points in time, the user's pronunciation scores at a phonemic level, are monitored, and exercises delivered to address their specific pronunciation challenges. At the same time, controls are provided that enable users to selectively adjust the playback speed of the multimedia audio track to enable them to better comprehend the narration, or obtain definitions or translations of any word or expression within the content to improve their vocabulary.

Users want to learn a language wherever and whenever they have the time to do so. The disclosed system delivers training over the Internet to any connected computer or computing device. At the same time, some or all of the training content can be pushed or synchronized to a mobile device such that a user can continue working with the content while away from their computers.

The content players on each device also operate in a limited capacity while the device is offline or unable to connect to the Internet. This allows users to work and interact with any content already downloaded to the device even if that device does not have an Internet connection at that time.

The typical classroom learning environment provides a high degree of social interaction which is not available when users learn through online tools. Interactivity is provided to enable social interaction that is lost with other systems.

By matching users at the same learning level and with common interests, the portal can bring multiple users together through online discussion forums and chat rooms. While a user is working through content in the player, they can see other users working on the same content and choose to work together on it or start an online chat session. Through an integrated VoIP component, users can read the same story elements together in a collaborative fashion to emulate an in-class session or discussion.

Content authors have a desire to publish their content for as wide an audience as possible. The reader's ability to absorb that content can be significantly impacted if their language abilities are limited. A platform is provided through which content authors and publishers can deliver their content that makes it valuable to those consumers who would not otherwise be able to absorb it, while helping them improve their English language proficiencies as they work with that content.

Given this system's global appeal and the wide deployment models possible (direct to consumer, enterprise training solutions, OEM partner portal offerings), the system supports a number of business models through its back-end business logic implementation on the platform server. A free for use consumer offering is supported through an ad based revenue model where both the portal and the player are capable of displaying text based and rich media ads to end-users that are contextually driven from the content being viewed and/or the user's profile information. These capabilities can be selectively turned off when the user has paid for a subscription or for viewing specific premium content.

For enterprise sales, the system allows a block of licenses to be purchased and managed by a specified administrator user who can then further assign these licenses to named users that they create and manage through the system's administrative portal. Secure access is provided to content on a subscription or pay per title basis.

Some unique aspects of the system that are provided are that:
Existing content is leveraged in a flexible manner to enable users to learn a new language in a way that adapts to their current abilities.
A user's voice can be recorded over time to provide a historical view of the pronunciation improvements as the user progresses through their training. Historical recordings can be selectively played back for review purposes by the end user or a parent/teacher/trainer remotely through the portal.
Audio and video content can be played back at a user selectable speed that maintains audio quality with no change in pitch. The speed of the word highlighting within the text transcript is adjusted accordingly so that regardless of the playback rate, the media and word highlighted text transcripts are kept perfectly synchronized.
Vocabulary assistance for unknown words is provided to the user. This is done in an intelligent fashion that provides the definition based on the context that the word is used in and supports definitions for multi-word expressions and unique terms through custom definitions embedded in the content itself.
An assessment component within the player identifies a user's current fluency level and directs the user along a specific content stream that is targeted at their current abilities.
Pronunciation coaching is provided that uses an integrated speech recognition engine to score the user's pronunciation against a native English speaker and provide immediate feedback on the users' speaking abilities. It leverages the resulting data collected from this pronunciation scoring engine to provide the user with a specific learning stream to address their pronunciation training needs.
Pronunciation feedback is provided immediately after a user reads a section of text. Words in the text pronounced correctly are coloured green, words mispronounced are coloured yellow or red depending on how severe the mispronunciation as compared to a native speaker. If the user subsequently selects an individual word for further analysis, the phonemes within that word will be identified and highlighted in a similar fashion, with phonemes correctly pronounced coloured in green, while phonemes that were mispronounced would be coloured yellow or red.
Content is delivered with an indexed transcript that is synchronized to the audio track of the multimedia elements. This transcript includes information that identifies the individual actors or speakers within the content to facilitate role playing exercises and dialogue simulation.
Dialogue can be simulated where the user can “play” the part of a speaker in a conversation. As a single user, this is managed by the user speaking or reading the lines in the transcript identified as being spoken by their chosen character.
A multi-person implementation is supported through a VoIP component where multiple users at different locations can each choose a character and role play a scene, dialogue, or discussion.
Portal access provides users with a score that allows them to compare themselves against similar users in the community. Provides the ability to measure their progress in relation to others, and to locate and associate with other members of the community.
Content player delivers contextual advertising depending on the content being played and the current user's subscription level.
Content server allows publishers or end-users to upload media to the transcription engine for parsing. Once uploaded, the audio or audio/video media is processed to produce an indexed transcript file. This can then be reviewed and edited by the content creator before being published to the community.
Community portal and content creation tools support a tiered content structure providing everything from free content, to pay-per-use content with the backend application managing licensing and royalty payment terms.
Publishing system provides a high level of control over manual content publishing as well as an automated workflow to support high volume content publishing from news or other content sources without any human intervention.

As shown in FIG. 1 the content 108 is available through the internet 110 such as news, magazine, special interest website, blogs, etc. . . . although it may be provided by media sources such as compact disc (CD), digital video disc (DVD), books, papers or other media distribution sources. The web-based sources of content may be media sources such as news sites or sites related to specific content topics. The content may be a single source or multiple sources, either freely accessible or provided on a subscription basis. The media may be in the form of audio only, video (with audio), and/or text content. Selected content is processed by authoring tools 106 which adapts the content to a format specific to facilitating language training. The authoring tools may be resident on the platform server or may be executed on an independent computing device. This content is then published to a content server 104. The platform server 102 indexes and categorizes the available content. The content is indexed utilizing defined metadata criteria and is administered and advertised through the servers. The content is accessed through the internet 110 by a content player 112 resident on various computing devices such as mobile phone 114, smart phone 116, personal digital assistance 118, or personal computer or laptop 120. This enables all or parts of the content to be pushed to a mobile device such as an MP3 player, PDA, or cell phone to enable learning on the go.

All activities associated with specific content such as how far into the content the user has gone, or any scores associated with the content itself that has been accumulated through the user's interaction with that content are sent to the platform servers. A user may start interacting with the content on a mobile device but continue with the same content at a later time on a full-featured terminal such as a laptop or desktop PC. By storing all of the scores and progress information centrally, and synchronizing this information between the different players that a single user might leverage, the user's experience of the content flow will track the user's progress regardless of which devices they switch between.

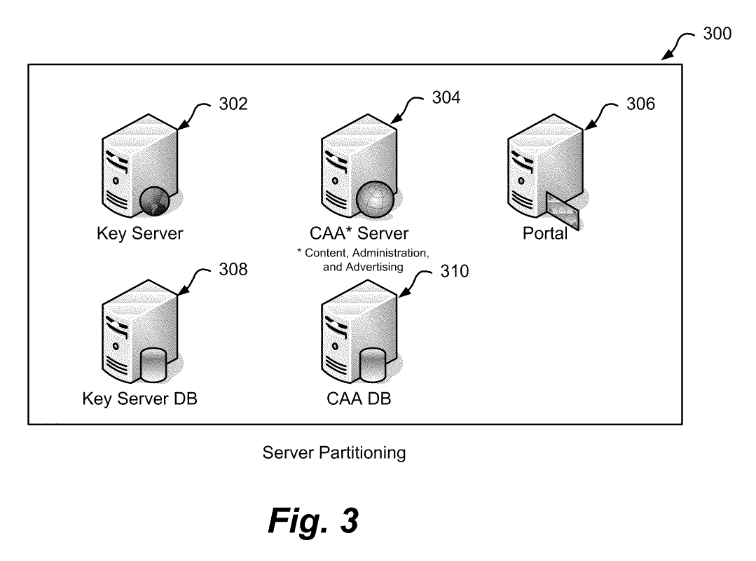

The platform servers and content servers can be distributed and replicated around the globe to provide redundancy and scalability. By distributing these servers within hosting facilities close to the end-user, latency during content downloads can be minimized. The specifics in which the different platform functionality is subdivided across the different servers is further detailed in FIG. 3.

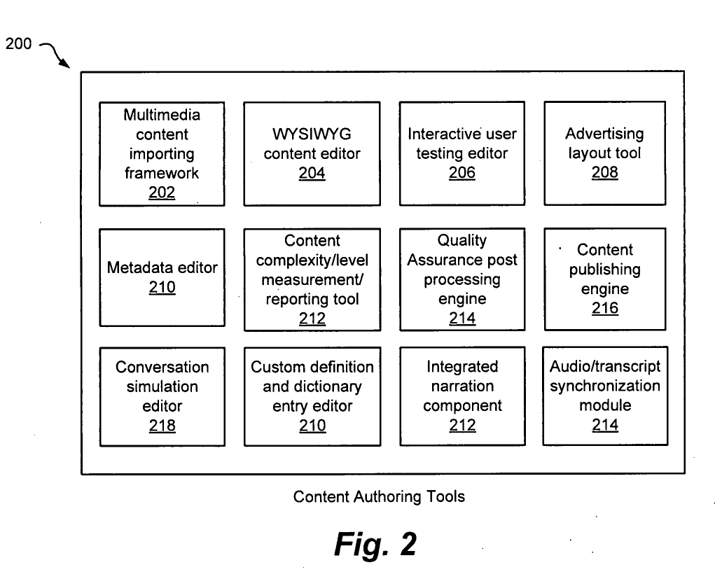

FIG. 2 is a block diagram of content authoring tools providing, multimedia content importing framework 202, a WYSIWYG content editor 204, an interactive user testing editor 206, an advertising layout tool 208; a meta data editor 210; a content complexity/level measurement/reporting tool 212; quality assurance post processing engine 214; content publishing engine 216; conversation simulation editor 218; custom definition entry editor 210; integrated narration component 212; and audio/transcript synchronization module 214. These tools are utilized to process content to enable use with the language training system.

The metadata editor allows descriptive data associated with the content to be captured. This can include a web URL that points to the content itself, the content category, type, keywords, abstract or summary, etc. . . . Some metadata is shared across all content on the system, but a content publisher can also specify metadata that is unique to their content. Any content identified with this publisher will then inherit the custom meta data fields associated with that publisher.

The conversation simulation editor allows the content author to associate specific actors or speakers to specific sections of the content being created that will be leveraged in the content player to simulate a conversation or social interaction. Metadata is generated that identifies speakers within the narrated audio or media files and the associated text. The roles for each of the speakers can then be selected by a user in the content player. The roles can also be used to enable a number of users to interact using the same content, each user taking a role within the content to simulate a conversation.

While the content is being authored, some words or expressions in the content may be used out of context or used in a manner that falls outside of the traditional definition for those words. The custom definition dictionary entry editor allows those words or expressions to be identified and the correct definitions and translations to be provided for these.

To engage the content reader, a number of interactive exercises can be provided that test their comprehension, writing, or listening skills and determine an assessment score. The interactive user testing editor allows these interactive elements to be created and laid out in the content. The possible correct responses and scoring multipliers associated with these are also provided through this module.

An integrated narration component allows the content imported into the authoring tool to be narrated by a human narrator or high quality text-to-speech (TTS) engine. It provides a mechanism for a narrator to read the text in a continuous pass and provides word level synchronization of the content as it is being narrated. If a narrator pauses or makes an error during narration, they can simply re-narrate that portion and the narration component will seamlessly combine the new recordings into the previously recorded streams.

The advertising layout tool allows ad templates to be integrated into the content and the business rules associated with the display of those ads to be provided. Ads can be restricted to only be shown to free or trial users but not displayed to paid subscribers, etc. . . .

Prior to publishing the content, the quality assurance and post processing engine can be used to run through a set of checks to ensure a high degree of quality of the content published while automating the tests that are very time consuming to do manually. With the audio narration of content required, the quality assurance tests will ensure that all content has been completely narrated. It will highlight any areas of the content that have not been narrated and provide controls to normalize the narration of the unit if it has been narrated at different volume levels. It also provides proof-reading functionality that will check the spelling and grammar of the content at the same time. If there are required elements of the content that are not present, this component will flag those to the content author.

The system allows content authors to have complete control over the content that they publish through the publishing front-end. This tool allows a unit to be storyboarded, edited, and narrated. For content authors who do not have the ability to narrate their own content (due to language abilities for instance), the publishing mechanism supports a selection of narration options from a TTS based narration process through to a studio quality narration service.

A mechanism for publishing high volume content is also supported where content can be pulled from a source, formatted, and narrated through a high quality TTS engine, and published to end users of the system with no human intervention. This provides a highly scalable solution to provide a wide selection of news stories, blog articles, and other content for end-users of the system.

The system also provides publishers with a flexible choice of how content is published. Content can be made freely available on a system wide basis to all users, or can be offered at a premium on a pay for use basis.

FIG. 3 is a schematic representation of platform server 300 partitioning. The platform server 300 provides a key server 302 for enabling users to access content in connection with a key server database 308; content administrating and advertising server 304 in connection with a content, administration and advertising (CAA) database 310; a portal interface 306 for providing access to the content and providing users with reporting and community based features.

The key server provides for the creation and management of product keys that are used to control the licenses of the content player. A product key is required to install and use the content player and dictates on how many unique computers the player can be installed as well as the duration of the license. Product keys can be issued with a specified license duration and extended at a later date to provide the user with continued service. This is done to support subscription based services where a user may purchase an initial 30 day license but look to renew that license on a monthly basis. Once the license has expired, the user is prevented from further use of the player or previously downloaded content.

The benefit from having a key server which is separate and distinct from the other servers is that an organization may choose to control the creation and management of all player product keys but want the flexibility of licensing the platform technology to other partners. These partners for different business or technical reasons may want to manage and host their own CAA and content servers. This distributed architecture supports this flexibility while maintaining control of the product and content licensing components.

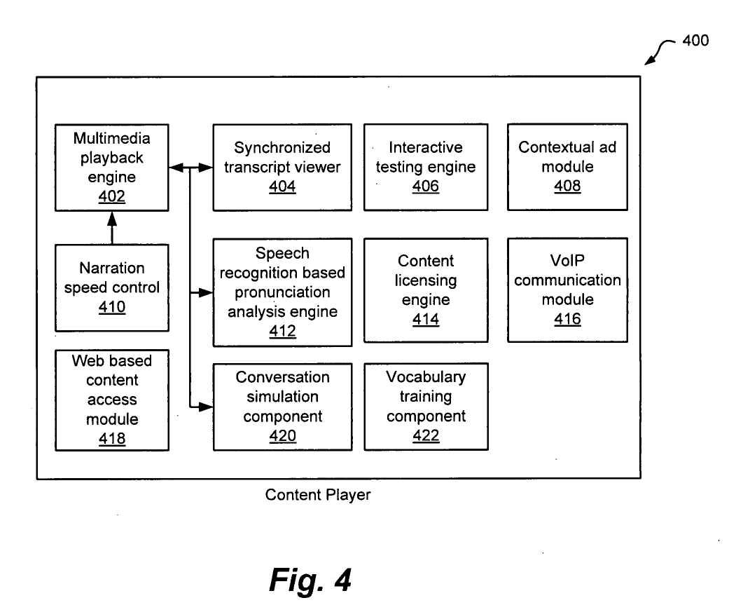

FIG. 4 is a block diagram of the content player/viewer. The content player operating on a computing device provides a multimedia playback engine 402; synchronized transcript viewer 404; interactive testing engine 406; contextual ad module 408 for delivering ads related to the content to the end user; narration speed control module 410; speech recognition based pronunciation and analysis engine 412; content licensing engine 414; voice-over-internet-protocol (VOIP) module 416; web based content access module 418; conversation simulation component 420 and vocabulary training component 422.

When a user is provided with the transcript of a narrated story, they may often have trouble following where they are in the text. This issue can be addressed by highlighting the current word or sentence being spoken in the audio track in the transcript text through visual cues which are provided through the synchronized transcript viewer.

When working with new content, users often encounter words or expressions that are unfamiliar to them. To improve their comprehension of the content and grow their vocabulary, the vocabulary training component allows them to quickly find definitions for unknown words or expressions in the language of the content itself, or their mother tongue. In addition intelligent definitions that are keyed to the word's part of speech as used in the content text are provided. If two or more words are part of a common term or expression, both words are highlighted and the expression that it refers to is described as opposed to simply the definitions of the individual words on their own. Custom definitions that are delivered as part of a content package are added to the internal dictionary's set of definitions for future reference.

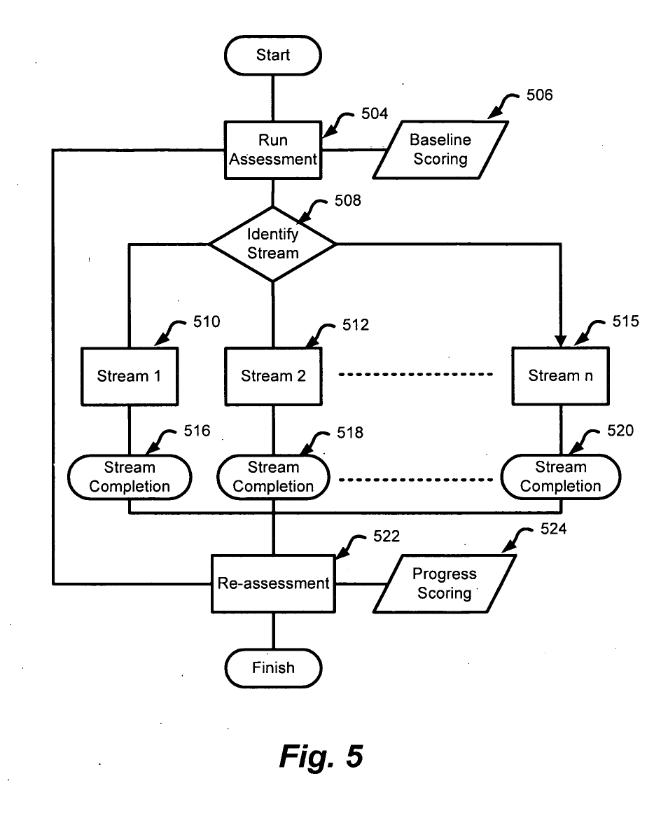

FIG. 5 is a method diagram of assessment driven user streaming. An assessment is performed at step 504 utilizing a baseline score 506 previously assessed for the user if available. Assessment is performed using the interactive testing engine 406 and the speech recognition based pronunciation analysis engine 412. The language skill level and an associated learning stream is then identified at step 508 using assessment data. Each stream, for example stream 1 510, stream 2 512 to stream n 515 defines the learning profile for the user in relation to the content available. Once the user has completed the training stream at step 516, 518 and 520 re-assessment may be performed at step 522 and a snapshot of their latest progress scoring captured 524. If the learning objectives have been achieved the method is completed. During the users progress through the language training stream, an intervention may be performed based upon collected performance data. The intervention provides intervention units to further improve particular phonemes that have been identified as weak during training.

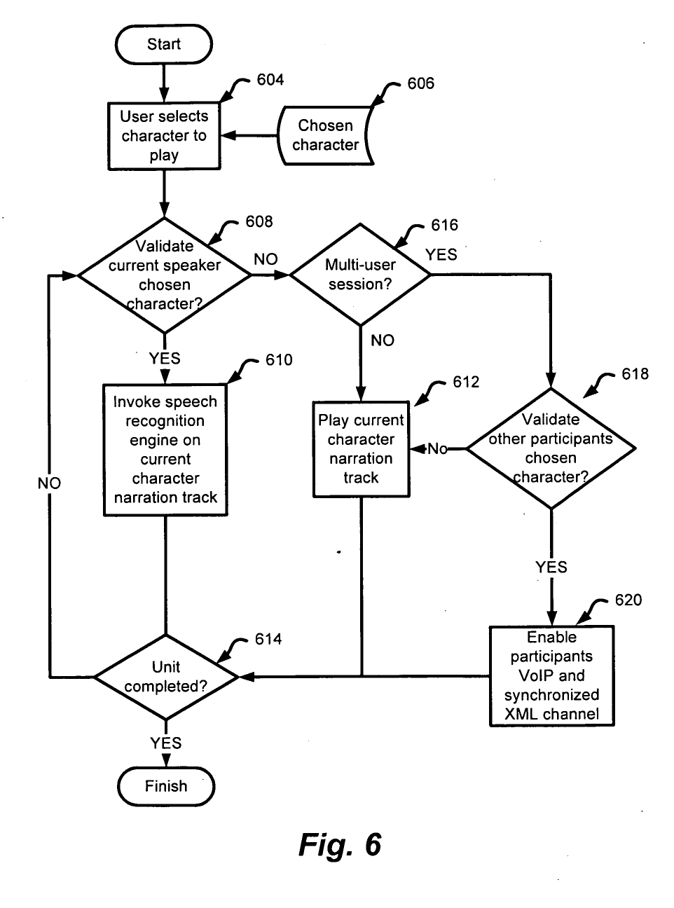

FIG. 6 is a method diagram for a conversation simulation engine to enable a user to engage in either a simulated conversation based upon the provided content or interact with another student, each taking a role in the conversation defined in the content. The metadata associated with the content provides identification of the participants within the conversation provided by the content unit. The method starts with the user selecting a character to play in the conversation 604. The character to be played by the user will be defined and chosen 606 relative to the available roles in the conversation itself, or actors in a movie scene. As the content narration track is played, the current speaker is validated against the user's chosen role 608. If the narrator is not the user's character, it is played out as recorded 612, but if the narration track is spoken by the role chosen by the user, the user is prompted to speak their lines from the dialogue 610. This continues until the dialogue comes to an end 614.

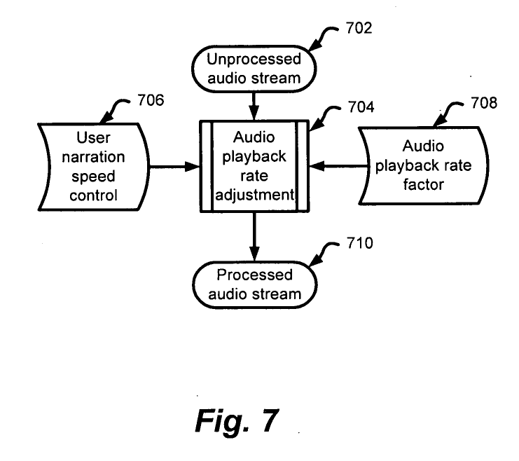

FIG. 7 is a schematic representation of intelligent audio narration speed control used during playback of content by the content player. The audio stream 702 is processed by the content player. The user can adjust the narration speed 706 which is used as an input by an audio player 704 of the content player. A rate factor 708 defines how the speed of the audio track was adjusted and is used as an input in the text synchronization component to adjust the speed of the synchronized transcript viewer 404. The processed stream 710 is then played to the user. The user can then adjust playback speed to improve comprehension.

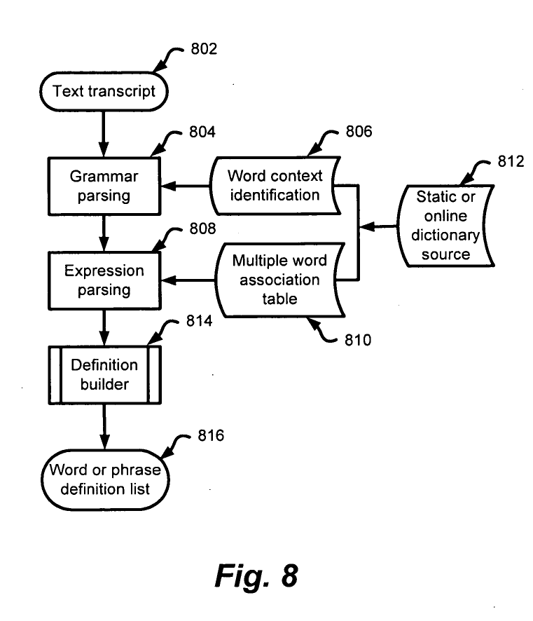

FIG. 8 is a schematic representation of context sensitive vocabulary assistance provided within the content player to enable additional dictionary definitions, vocabulary assistance or other context specific tools to be provided to the user within the context of the content provided. The text transcription is provided at step 802. The transcription is parsed for grammar and context at step 804 utilizing the word context identification table 806. The output of the grammar parser are words in context. This output is then passed through the expression parser along with a multiple word association table 810 to determine where multi-word expressions and idioms appear in the text. The output from the expression parser is then passed to the definition builder 814 which compiles a list of single word and multiple word occurrences in the text and associates a context dependent definition for each by leveraging a static or online accessible dictionary source 812. The word or phrase definition list can then be produced at step 816. Additional audio or video data can be added to the vocabulary assistance to help improve comprehension and provide relevant context sensitive assistance to the user.

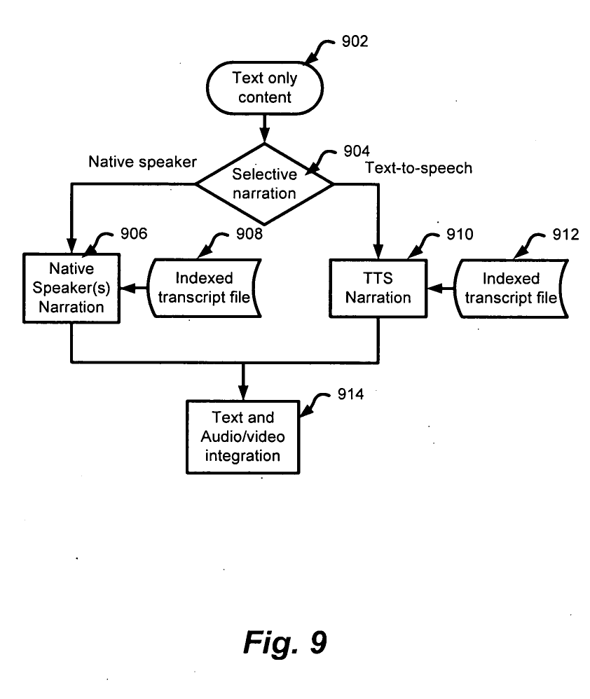

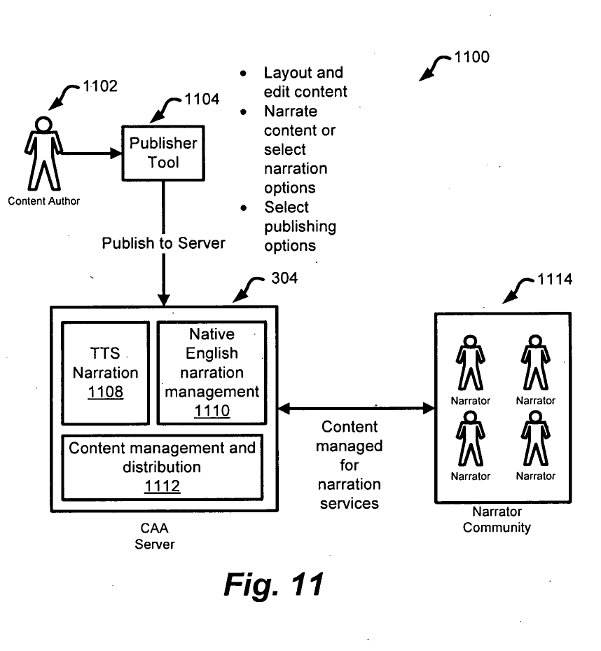

FIG. 9 is a schematic representation of content creation flow for text-only original content to produce content packages by multimedia content importing framework 202. When text only content 902 is provided, the type of audio narration to be provided with the content can be selected at step 904. If text-to-speech is selected, a high quality text-to-speech engine is used to narrate the text at step 910 which is indexed to a transcription file 912. If native speaker narration is selected, a native human speaker will narrate the text in step 906 which again can be indexed to a transcription file 908. For the native speaker narration, a community of readers can be leveraged as shown in FIG. 11 (1114). The text and audio/video can then be integrated at step 914 for the multimedia experience.

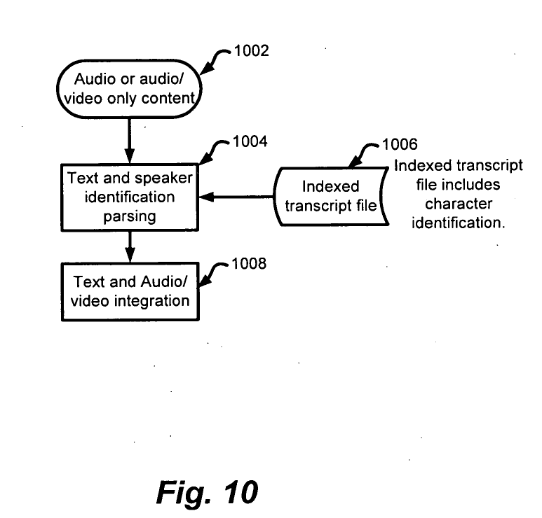

FIG. 10 is a schematic representation of content flow for audio or audio/video based content utilizing the multimedia content importing framework 202. Audio or audio/video content is provided at step 1002. The text and speaker identification are associated with the content utilizing an indexed transcription file 1006. The text and audio/video are then integrated at step 1008 which includes speaker identification data used in the conversation simulation component 420.

FIG. 11 is a schematic representation of the publishing workflow to produce content packages using authoring tools. The publishing tool 1104 enables a content author 1102 to layout and edit content, narrate content or select narration options and select publishing options. The content is then published to the server or to the CM server 304 on the platform server. The content is then either narrated with the TTS narration 1108, or through the native English narration management component 1110 depending on what was selected by the content author at the time of publishing. In the later case the content can be narrated, in a scalable fashion, through managed/hosted narration services provided by a narrator community 1114. The content is then distributed to the user community through the content management and distribution component 1112 provided by the platform server 102.

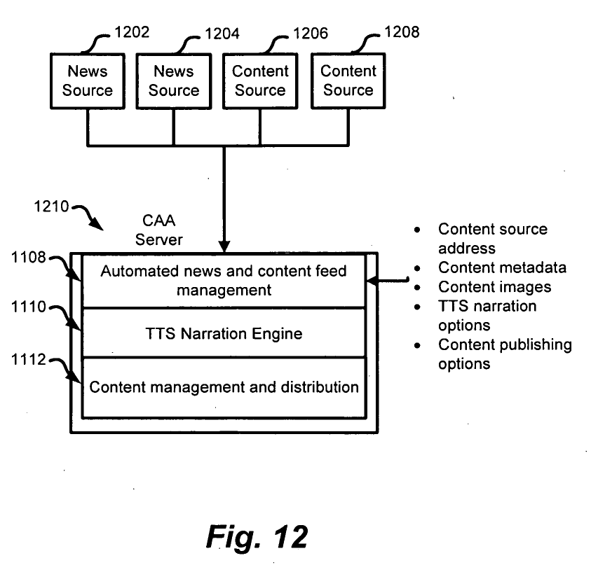

FIG. 12 is a schematic representation of publishing workflow in which content is published to the content server in an automated fashion 104. Various content sources such as news sites or sources 1202 and 1204 in addition to other content sources such as document libraries or media archives 1206 and 1208 are pulled from by the automated news and content feed management component 1108 on the CM server 304. The CM server adds content source address, content metadata, content images, TTS narration options and content publishing options for each specific content source. TTS narration is used in this workflow to narrate the content 1110, providing a completely scalable and automated approach to content publishing. The management and distribution of this content is provided through the content management and distribution component 1112 on the CM server.

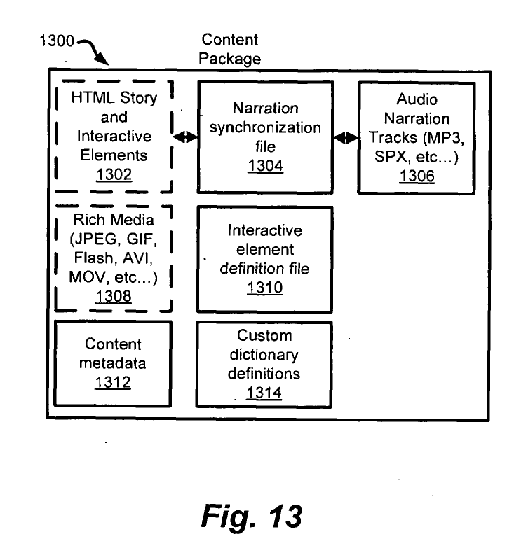

FIG. 13 is a schematic representation of content package that encapsulates a content unit including language metadata and categorization. The original source content may be stored within the content package itself or stored separately and referenced within the package through a URL for instance. The package 1300 may include metadata such as HTML story and interactive elements 1302, narration synchronization file 1304, audio narration tracks 1306 such as MP3, SPX, etc. formats, rich media files 1308 such as JPEG, GIF, Flash, AVI, MOV, etc., an interactive element definition file 1310; content metadata 1312 such a context sensitive vocabulary assistance and custom dictionary definitions 1314.

The content and its interactive elements (quizzes and tests) are depicted in block 1302. The block represents the content itself or a link to the content available over the Internet. All narrated elements of the content are stored in audio files referenced in block 1306. A narration synchronization file 1304 provides a link with timing information between the content in block 1302 and the audio narration of that content in 1306. Rich media files are stored in their native format(s) in block 1308. For interactive elements, the definition files that relate to the interactive components in the content are stored in 1310. These include the correct responses associated with these tests and their associated scoring methods. Any custom dictionary definitions and translations associated with words or expressions in the content itself are stored in 1314. The content metadata that provides information relating to the content unit itself is stored in 1312. This metadata comprises information that is common to all content on the system as well as publisher specific meta data which is unique to that specific publisher.

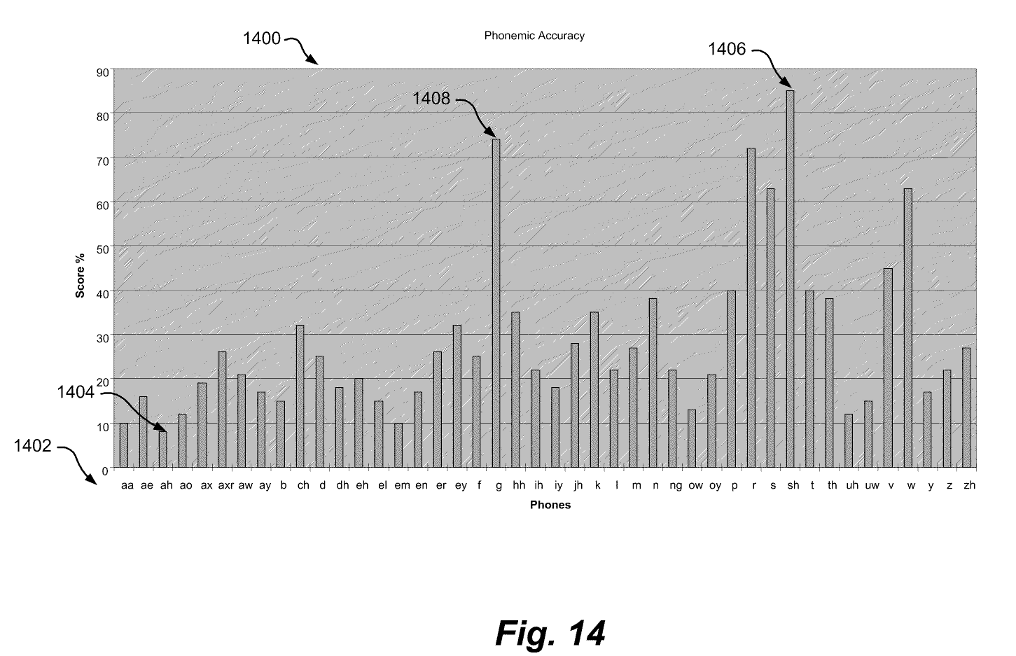

FIG. 14 is a graphical representation of the phonemic scoring data for a particular user as derived from the pronunciation and analysis engine 412. The chart 1400 is comprised of historical phonemic scoring data for all of the phones in the English language 1402. The chart shows the average of all phonemic scores captured over a specified time period. To highlight problem phonemes, the scores are shown inversely proportionally to how correctly they were spoken over time. A low score for a specific phoneme indicates that these phonemes have generally been pronounced correctly over that period such as the ah phoneme 1404. This allows the chart to highlight to the user which phonemes they are having particular difficulties with such as the ‘sh’ 1406 and ‘g’ 1408 phonemes.

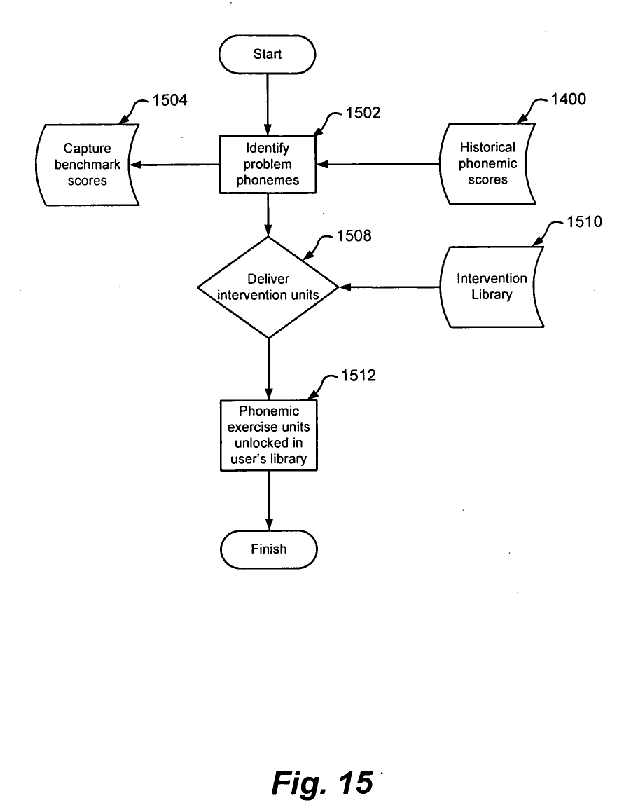

FIG. 15 depicts a method that leverages a user's phonemic data 1400 to provide custom interventions that provide content specifically developed to provide instruction on and practice lessons in addressing the challenges in pronouncing specific phonemes. The historical phonemic data is analysed in 1502 and stored for later comparison in 1504. These benchmark scores can then be used as a comparative measure to determine the effect that the intervention units have had on the user's subsequent pronunciations of those phonemes over a future time period. The analysis identifies specific phonemes that the user is having particular difficulties in pronouncing under different circumstances and will match those phonemes in 1502 against a library of practice exercises 1510 which were developed to coach users with instructions, videos, exercises, and feedback on how to properly pronounce the individual sounds of the English language and are delivered to the user in 1508. These units are then made available to the user in their personal content library 1512. It can thus be shown that as a user works through English language material on the platform, they will be given a customized set of lessons that are delivered to them based on the unique characteristics of their own speaking style, which may be influenced by their mother tongue or other personal characteristics.

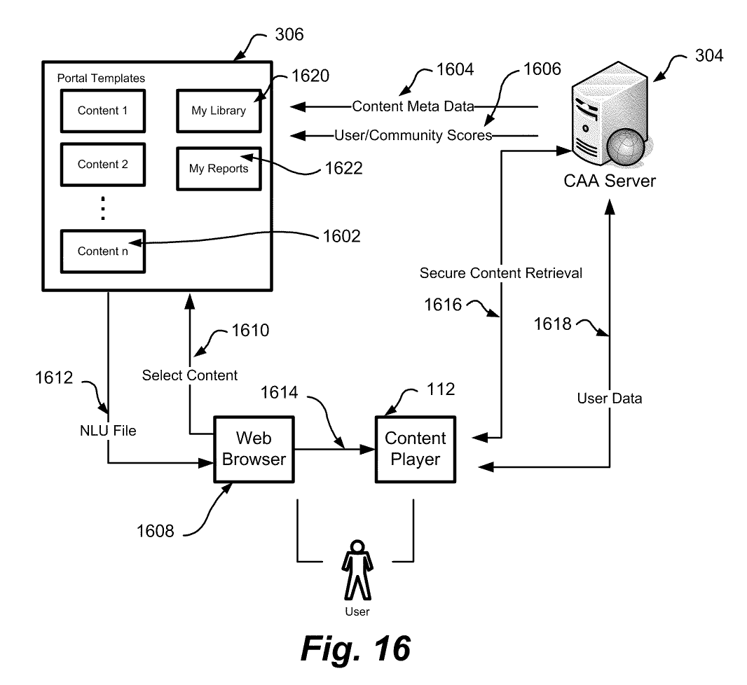

FIG. 16 represents a method diagram for user content requests and score data retrieval from the community portal 306. The portal content pages consist of multiple templates 1602, these templates define how content metadata 1604 retrieved from the CAA server 304 will be displayed to the user. The templates are generated using any number of web authoring tools to generate for example HTML, XML, Flash™ or Java™ interactive webpages or applets. This allows the appearance of content within the portal to be updated and presented dynamically through the content publishing process without the need to have this updated or maintained manually. The rich content metadata provides flexibility in how this content will be categorized and presented within the portal pages. The user and community scores data 1606 allow dynamic data to be included within the content templates such as the content popularity based on the number of times the content is downloaded, as well as provide recommendations to the user of content that they might enjoy based on the behaviour of other users within the community.

The presentation of the content within the portal allows a user to browse through the content through a standard web browser 1608 and select the content to be downloaded 1610 and experienced within the content player 112. Once the user has selected content for download the portal responds by providing the web browser with a temporary file called an NLU file 1612. This NLU file uniquely identifies the content within the CAA server to enable the content player to access the specific file. The browser will launch the content player if it is not already open and passes this file 1614 to the content player. The player then uses the unique identifier to initiate a content download session 1616 from the CAA. After the CAA ensures that the user is authorized to view the requested content, the content package is downloaded into the player and is available for the user to interact with. In addition to the content itself, the CAA will provide the content player with any user data 1618 that is required to synchronize the current player with the user's last known progress with that content that might have occurred on a different device.

Any user data resulting from the interaction with the selected content is sent back to the CAA 1618 for storage. This data includes the user's progress through the content and any associated scores. It may also include voice recordings and other data from any of the pronunciation, reading, and interactive exercises.

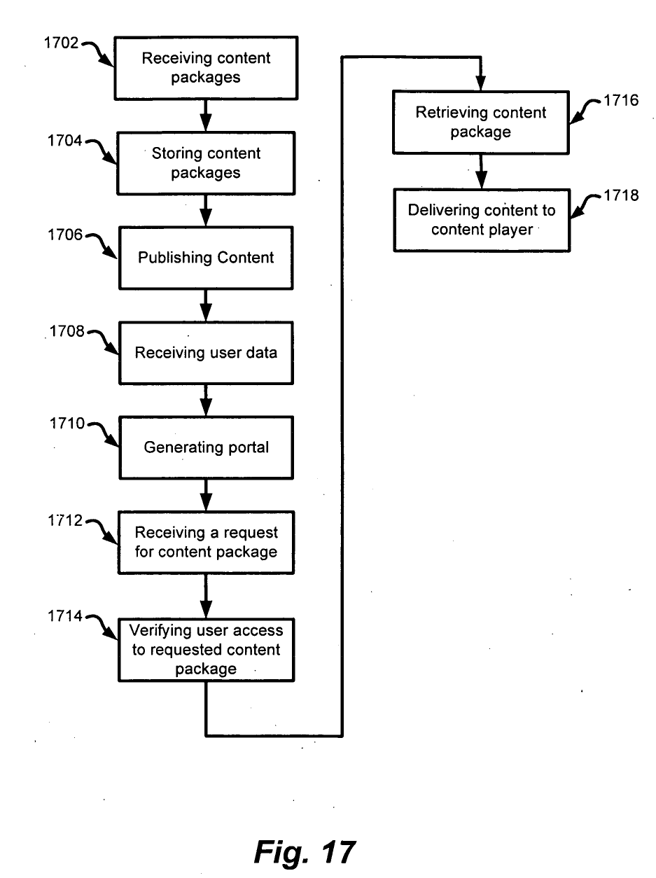

Any scores or user data associated with content interactions are immediately available through the My Library section 1620 of the portal which provides up-to-date scoring information to the user through the data 1606 delivered from the CAA. In addition, aggregate reports that capture a user's progress over time as well as a comparison of how they are doing as compared to other users within the community can be found in the My Reports section of the portal 1622. FIG. 17 show a method of providing interactive language training. Content units are processed from one or more native English language content sources, to generate language training and categorization metadata associated with the content and synchronizing the narrated audio track to an associated transcript file. The processing can occur at a platform server or on another computer using authoring tools. The content units and language training and categorization metadata in content package are received by the platform server, or indexed to the platform server at 1702. The content packages are stored and indexed on a storage device at 1704. They can then be published by the platform server to enable user access to the content packages based upon associated user privilege level at 1706. The platform server will receive user data such as pronunciation scores or assessment data from a plurality of content players at 1708. Pronunciation scores defined at a word and phonemic level for each of a plurality of users used to determine appropriate content or appropriate intervention units to be provided to the users. Alternatively, assessment data is received identifying a language skill level used to define a learning stream and the appropriate content. A web-based portal can then be generated at 1710 by the platform server or by a dedicated web-server. The portal provides user specific data such as received language testing scores at an individual user and community level. The portal can also provide the content packages that are appropriate for the user language training level or intervention requirements. The web portal can dynamically display available content packages for access by the content player, and further provide searching capability for users to find and associate with each other for the purposes of interacting and learning utilizing the same content packages.

The user can then request specific content form the platform server. The platform server receives content requests from a web-interface or from a content player at 1712. The platform server can then verify access rights at the platform server for the user for the content package in a platform database at 1714. The content package is then retrieved from the storage device at 1716 and delivered to the content player through the network at 1718. Access can also be coordinated between content players the content players all accessing a particular content unit for providing interaction between users for a particular content unit using the transcript metadata.

The content player also enables testing to occur to determine a user's language level. This testing can be performed by the platform server using resources in the content player or be a separate module on the content player performing a standard suite of testing. The testing determines a level of language ability of the user and an associated training stream, each stream being associated with a level of content difficulty stored in the content unit metadata. Once the level data is received at the platform server, it can then determine content packages appropriate to the assessment data by matching skill level in the content unit metadata.

If the authoring process is automated, the platform server can periodically retrieve content from one or more content sources and generate automated text-to-speech narration (TTS). The narrated audio is synchronized with the text transcript, and TTS data is stored in the content unit metadata of the content package.

The method steps may be embodied in sets of executable machine code stored in a variety of formats such as object code or source code. Such code is described generically herein as programming code, or a computer program for simplification. Clearly, the executable machine code or portions of the code may be integrated with the code of other programs, implemented as subroutines, plug-ins, add-ons, software agents, by external program calls, in firmware or by other techniques as known in the art.

The embodiments may be executed by a computer processor or similar device programmed in the manner of method steps, or may be executed by an electronic system which is provided with means for executing these steps. Similarly, an electronic memory medium such computer diskettes, CD-ROMS, Random Access Memory (RAM), Read Only Memory (ROM) or similar computer software storage media known in the art, may be programmed to execute such method steps. As well, electronic signals representing these method steps may also be transmitted via a communication network.

The embodiments described above are intended to be illustrative only. The scope of the invention is therefore intended to be limited solely by the scope of the appended claims.

1. A system for providing interactive English language training through a network, the system comprising:
a content database, for storing content packages comprising content units and associated language training and categorization metadata, the metadata comprises synchronized audio and transcription data associated with the content unit; and
a portal web-server, for providing an interface for enabling users to interact with the content through the network; and
a platform server, for providing stored content packages and delivering the content packages to users to enable interactive English language training, the platform server controlling and restricting access by the each of the users to authorized content packages and providing content metadata and user data and community performance and networking data through the portal web-server.

2. The system of claim 1 further comprising:
a content player for accessing content packages by a user from the platform server, the content server executed on a computing device comprising:
an interactive testing engine for testing the user to generate language assessment data and language skill level;
pronunciation analysis engine for analyzing user speech input using a speech recognition module to determine pronunciation scores of the user for content units and for providing the determined scores to the platform server at a word and phonemic level; and
synchronized transcript viewer for using the content unit metadata to provide synchronization and transcription data to the user when accessing content units.

3. The system of claim 1 further comprising authoring tools, executed on a computing device, the authoring tools for generating English language training content packages using native English language content units, wherein the authoring tools comprises an audio and transcription synchronization module for generating the synchronized transcription data for storage in the content unit metadata.

4. The system of claim 3 wherein the authoring tools further comprises a content publishing engine for automating the generation of English language training content packages by automated text-to-speech (TTS) narration, synchronizing the narrated audio with the text transcript, and storing the TTS narration in the content package metadata.

5. The system of claim 2 wherein the authoring tools further comprises:
a conversation simulation editor for enabling simulation of a conversation between speakers represented in the content unit, the conversation simulation editor providing additional metadata that identifies speakers within a narrated audio track of the content unit, the metadata associated with the content and stored in the content package.

6. The system of claim 4 wherein the content player provides a conversation simulation module for using content units having conversation simulation metadata to allow the user to interact with the content unit in a virtual dialogue.

7. The system of claim 6 wherein the content player provides a voice-over-IP (VOIP) communication module for enabling two or more users of two or more content players to engage in a dialogue using the same content unit through the network.

8. The system of claim 2 wherein the content player further comprises an interactive testing engine for receiving assessment packages and performing and interactive language assessment of the user to determine a language skill level.

9. The system of claim 8 wherein the interactive testing engine provides the determined language skill level as assessment data incorporating pronunciation scores to the platform server, and the platform server provides access to content packages appropriate to the assessment data by matching language skill level to the content metadata.

10. The system of claim 1 wherein the pronunciation scores at a phonemic level are used by the platform server to identify a user below a target skill level, the platform server providing access to intervention units having lessons and drills relating to the identified phonemes through the portal.

11. The system of claim 2 wherein the content player further comprises:
a playback speed adjustment module for adjusting content playback speed of provided content; and
a vocabulary assistance module for providing assistance on particular words identified within the content provided.

12. A method of providing interactive English language training through a platform server on a network, the method comprising:
receiving content packages containing content units originating from one or more native English language content sources, the content packages also comprising language, categorization, transcription and synchronization metadata for use by a content player to enable user to interact with the content unit for language training;
storing and indexing the content packages on a storage device;
publishing content packages to enable user access to the content packages based upon associated user privilege level;
receiving pronunciation scores from content players, the determined scores defined at a word and phonemic level for each of a plurality of users based upon language assessment performed by the content player;
generating a web-based portal for providing access to content packages based upon the received pronunciation scores and for providing information regarding received scores at individual user and community level.

13. The method of claim 12 further comprising:
receiving an access request from the user for a content package;
verifying access rights at the platform server for the user to the content package in a platform database;
retrieving from the storage device the requested content package; and
delivering the requested content package to the content player.

14. The method of claim 13 further comprising:
coordinating access and communication between content players each associated with one of a plurality of users, the content players all accessing a particular content unit for providing interaction between users for a particular content unit using the transcript metadata.

15. The method of claim 12 further comprising:
performing an interactive language test of a user via the content player to determine a level of language ability of the user and an associated training stream, each stream being associated with a level of content difficulty stored in the content unit metadata;
receiving assessment data comprising the determined language training stream; and
determining content packages appropriate to the assessment data by matching skill level in the content unit metadata.

16. The method of claim 15 wherein generating the web portal is performed by dynamically displaying available content packages for access by the content player, and further providing searching capability for users to find and associate with each other for the purposes of interacting and learning utilizing the same content packages.

17. The method of claim 16 further comprising:
receiving pronunciation scores from a content player comprising phonemic pronunciation data to identify specific phonemes for which the user is below a target skill level; and
providing access to intervention units having targeted lessons and drills relating to the identified phonemes through the portal.

18. The method of claim 13 where in the content is web-based content comprises content from a news source website, an on-line magazine publication website or blog.

19. The method of claim 13 further comprising generating context sensitive vocabulary assistance data in the content unit metadata for providing additional dictionary data in the content player for vocabulary training that is content specific.

20. The method of claim 13 further comprising periodically retrieving content from one or more content sources and generating automated text-to-speech narration (TTS), synchronizing the narrated audio with the text transcript, and storing TTS data in the content unit metadata of the content package.
